(19) United States
(12) Patent Application Publication
(10) Pub. No.: US 2018/0055081 A1
(43) Pub. Date: Mar. 1, 2018

(54) Snack Food Seasoning Preparation and Related Compositions

(71) Applicants: Niranjan R. Gandhi, River Hills, WI (US); Franco X. Milani, De Forest, WI (US)

(72) Inventors: Niranjan R. Gandhi, River Hills, WI (US); Franco X. Milani, De Forest, WI (US)

(21) Appl. No.: 15/692,919

(22) Filed: Aug. 31, 2017

Related U.S. Application Data
(60) Provisional application No. 62/382,061, filed on Aug. 31, 2016.

(51) Int. Cl. A23L 27/00; A23P 30/25

(52) U.S. Cl. CPC A23L 27/88; A23V 2002/00; A23P 30/25

(57) ABSTRACT

Snack food seasoning compositions and related methods of preparation.

This application claims priority to and the benefit of application Ser. No. 62/382,061 filed Aug. 31, 2016, the entirety of which is incorporated herein by reference.

### BACKGROUND OF THE INVENTION

Cheese-flavored corn curls, balls and the like have been popular snack foods since their introduction in the 1930s. The process and product begins with a thick batter made from water and finely ground corn meal. The batter is then simultaneously heated and pressurized in a heated pressure extruder. Heating activates starch to form a network in the cornmeal matrix, while rapid gaseous expansion foams the matrix as it is extruded from the pressure zone. Included water is then driven off, with continued heat-setting of the starch, through a post-extrusion step such as deep fat oil frying or baking. Generally, the resulting product is known in the industry—regardless of starting material, composition or shape—as a collet. Flavor and seasoning, which typically employs cheese and other flavored powders suspended in oil, can then be applied to the collet surface to provide the snack food.

Shelf stability of snack foods is an important consideration. Such foods are designed to have a low moisture content to reduce microbial growth. Composition and production are significantly influenced by several related concerns. Manufacturers typically avoid addition of ingredients after drying that contain moisture. Removal of water after seasoning will drive off volatile flavor components and add significant drying costs. If not removed, moisture inherent to the cheese component of such a seasoning composition tends to separate, supports microbial growth and eventually results in a soggy, stale snack.

The collet is typically sprayed or tumbled with a seasoning composition. Such techniques are somewhat inefficient, in that a significant percentage of the seasoning may not adhere to the collet surface. A complicating factor relates to separation of the seasoning component, for example particulate settling, from an oil dispersion. Typically, during consumption of such snacks, the consumer will experience deposition of the seasoning. This is especially evident with brightly colored cheese snacks. The same orange residue experienced by and on the fingers of a consumer also quickly coats production equipment. Removal necessitates hours-long breaks in production, decreases efficiency and increases overall cost. As another related problem, not least of which, unstable oil dispersions, inefficient application and low collet adherence all contribute to an unsatisfactory snack food flavor.

### SUMMARY OF THE INVENTION

In light of the foregoing, it can be an object of the present invention to provide a range of snack food seasoning compositions and method(s) for their preparation and use, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can be an object of the present invention to provide various seasoning compositions and methods for their preparation, thereby limiting and controlling moisture migration within a corresponding snack food, and avoiding stale or soggy off-flavors.

It can be another object of the present invention to formulate such compositions to enhance shelf stability relative to food microbial pathogenic safety.

It can be another object of this invention to provide one or more methods and corresponding sequence of ingredient additions, with respect to a corresponding seasoning composition, to optimize antimicrobial control, as well as to optimize function and flavor delivery.

It can be another object of this invention to increase seasoning adherence, as relates to ingredient holding capacity, rate of acquisition of full adhesion strength and amount of seasoning incorporation, to a puffed snack collet.

It can also be an object of the present invention to maximize seasoning adhesion, reduce extraneous residue deposit and, thereby, lower production costs.

Other objects, features and benefits of the present invention will be apparent from the summary of the invention and its descriptions of various preferred embodiments, and will be readily apparent to those skilled in the art having knowledge regarding the preparation and seasoning of snack foods. Such objects, features, benefits and advantages will be apparent from the above as taken into conjunction with the accompanying examples, data, figures and all reasonable inferences to be drawn therefrom.

In part, the present invention can be directed to a method of preparing a snack food seasoning composition. Such a method can comprise providing a proteinaceous dairy starting material comprising an aqueous phase and flavor components; blending a salt component with such a starting material, such a salt component as can be in an amount for incorporation into the aqueous phase of such a starting material; and contacting such a dairy starting material and salt component with a lipid component selected from fats, oils and combinations thereof, and mixing such components and starting material for at least one of a time and at a temperature sufficient for extraction of such starting material flavor components into such a lipid component. Such a flavor-infused lipid can be collected to provide a snack food seasoning composition.

In certain non-limiting embodiments, such a dairy starting material can be selected from natural cheeses, enzyme-modified cheeses and combinations thereof. Regardless, the aqueous phase of such a dairy starting material can be the predominant source of water in such a composition. In certain such embodiments, such a salt component can be selected from alkaline and alkaline earth chlorides and phosphates and combinations thereof. Regardless of salt component identity, the aqueous phase of such a dairy starting material can be saturated with such a salt component.

Without limitation, such components and starting material can be mixed with an oil component and at a temperature to provide a fluidity sufficient for mixing over time without agglomeration. In certain embodiments, such components and starting material can be mixed at a temperature of about 5° C. to about 99° C. In certain such embodiments, mixing can be at a temperature of about 50° C. to about 60° C. Regardless, such a lipid component can be selected from most vegetable oils—typically but not limited to cottonseed oil, canola oil or soybean oil and combinations thereof.

Such a method can comprise incorporating an acid component with one or a blend of such a dairy material and salt components. In certain non-limiting embodiments, such an acid component can be selected from organic acids and inorganic acids, salts of such acids and combinations thereof. In certain such embodiments, such an acid component can be incorporated in an amount sufficient to provide such a seasoning composition a pH of less than about 6.0.

Such a method can also comprise incorporating a water binding agent, such an agent as can be selected from calcium carbonate, calcium phosphate, calcium sulfate, dry plant and animal proteins or protein fractions thereof, carbohydrates and cellulosic components and combinations thereof. Without limitation, such a binding agent can be in an amount sufficient to bind with the aqueous phase of such a dairy starting material. In certain embodiments, such a binding agent can be in an amount to provide such a composition without free water and inhibit water separation therefrom.

In certain embodiments, such a seasoning composition can be incorporated with a snack collet. As discussed elsewhere herein or as would be understood by one skilled in the art, such incorporation can be, without limitation, accomplished through surface applicationto, sub-surface incorporation of or co-extrusion with such a snack collet.

In part, the present invention can also be directed to an alternate method of preparing a snack food seasoning composition. Such a method can comprise providing an enzyme-modified cheese starting material comprising an aqueous phase and flavor components; blending a salt component with such a starting material, such a salt component as can be in an amount for incorporation into the aqueous phase of such a starting material; blending an acid component with one or a blend of such a starting material and salt component, such an acid component as can be selected from organic and inorganic acids, salts of such acids and combinations thereof; and contacting such a blend with an oil component and mixing such components and starting material at a temperature sufficient for extraction of such flavor components into such an oil component. Such a flavor-infused oil can be collected to provide a snack food seasoning composition with one or a combination of pH, water activity and salt-in-moisture factors sufficient to inhibit microbial growth.

Without limitation, regardless of starting material, such a salt component can be in an amount sufficient to provide a salt-in-moisture ratio of about 0.15 or less to about 0.75 or more. In certain embodiments, a salt-in-moisture ratio can be about 0.20 to about 0.60. In certain such embodiments, such a ratio can be about 0.30 to about 0.55. In yet other embodiments, such a ratio can be about 0.40 to about 0.50. As a separate consideration, such an acid component can be in an amount sufficient to provide such a composition a pH of less than about 5.0.

In certain non-limiting embodiments, the aqueous phase of such a material can be the sole source of water in such a composition. In certain such embodiments, without limitation, such a salt component can be selected from alkaline and alkaline earth chlorides and phosphates and combinations thereof. Regardless of salt component identity, the aqueous phase of such a starting material can be saturated with such a salt component.

Without limitation, such components and starting material can be mixed with an oil component and at a temperature to provide a fluidity sufficient for mixing over time without agglomeration. In certain non-limiting embodiments, such components and starting material can be mixed at a temperature of about 5° C. to about 99° C. In certain such embodiments, mixing can be at a temperature of about 50° C. to about 60° C. Regardless, such an oil component can be selected from vegetable oils—such as but not limited to cottonseed oil, canola oil and soybean oil and combinations thereof.

In certain non-limiting embodiments, such an acid component can be selected from organic acids, salts of such acids and combinations thereof. Regardless, in certain such embodiments, such an acid component can be incorporated in an amount sufficient to provide such a seasoning composition a pH of about 4.0 to about 5.0.

Such a method can also comprise incorporating a water binding agent, such an agent as can be selected from calcium carbonate, calcium phosphate, calcium sulfate, dry plant and animal proteins or protein fractions, carbohydrates and cellulosic components and combinations thereof. Without limitation, such a binding agent can be in an amount sufficient to bind with the aqueous phase of such a starting material. In certain embodiments, such a binding agent can be in an amount to provide such a composition without free water and inhibit water separation therefrom.

In certain embodiments, such a seasoning composition can be incorporated with a snack collet. As discussed elsewhere herein or as would be understood by one skilled in the art, such incorporation can be, without limitation, accomplished through surface application to, sub-surface incorporation of or co-extrusion with such a snack collet.

In part, the present invention can also be directed to a snack seasoning composition comprising a lipid component selected from fats, oils and combinations thereof; a seasoning component comprising a cheese flavor component and a water component, such a seasoning component as can be about 30 wt % to about 75 wt % of such a composition; a salt component in an amount sufficient to provide such a composition a salt-in-moisture ratio of about 0.15 or less to about 0.75 or more; a non-limiting acid component selected from organic acids, salts of organic acids and combinations thereof, such an acid component as can be present in amount to provide such a composition a pH of about 4.0 to about 5.0, such a composition as can have at least one of a pH, water activity and salt-in-moisture ratio sufficient to inhibit microbial growth. In certain embodiments, a salt-in-moisture ratio can be about 0.20 to about 0.60. In certain such embodiments, such a ratio can be about 0.30 to about 0.55. In yet other embodiments, such a ratio can be about 0.40 to about 0.50.

In certain embodiments, such salt, acid and oil components can be independently selected from components of the sort discussed above or illustrated elsewhere herein. In certain such embodiments, such a cheese flavor component can be selected from natural cheese flavors, enzyme-modified cheese flavors and combinations thereof; and an oil component can be independently selected from cottonseed oil, vegetable oil and combinations thereof. Without limitation, such an oil component can be about 45 wt % to about 70 wt % of such a seasoning composition. Regardless, such a composition can also comprise one or more water binding agents of the sort discussed above or illustrated elsewhere herein. Whether or not such a seasoning component is the sole source of water, such an agent as can be in an amount to reduce or eliminate free water, and inhibit water separation from such a composition.

In part, the present invention can also be directed to a snack food composition comprising a snack food collet and a seasoning composition of the sort discussed above or illustrated elsewhere herein. Such a collet can comprise any material understood by those skilled in the art as useful in the preparation thereof. Without limitation, a collet can be prepared, as discussed above and illustrated below, from ground corn meal. Regardless, such a seasoning composition can be applied to the surface of such a collet. Alternatively, a seasoning composition of this invention can be incorporated within the collet during production. For instance, without limitation, collet and seasoning composition can be co-extruded for incorporation of seasoning directly within the collet matrix.

### BRIEF DESCRIPTION OF THE DRAWINGS

FIG. 1 provides a graphic illustration of moisture isotherms and affect on water activity.

### DETAILED DESCRIPTION OF CERTAIN EMBODIMENTS

Certain non-limiting embodiments of this invention, including various compositions, formulations, methods, and processing approaches can be used effectively to limit and control water movement and, in doing so, provide shelf stable snack foods. Without limitation, various starting material and component sequence of mixing can optimize snack food flavor, texture, water migration, or microbial control, or any combination thereof. One such sequence, corresponding formulation and resulting composition can comprise: 1) provision of a natural cheese or an enzyme-modified cheese or additional fat source or combination thereof, with addition of organic acid(s) such as but not limited to food grade acetic, adipic, citric, lactic and glucono-delta-lactic acid and food grade inorganic acid(s) such as but not limited to sulfuric and phosphoric acid to decrease pH and increase titratable acidity; 2) prior or subsequent addition of salts to allow for complete dissolution into the aqueous phase and effect antimicrobial action; 3) addition of water binding components, for example but not limited to plant or animal proteins, whey, whey protein concentrates, whey fractions, casein, caseinates, caseinate fractions, starches, dextrins, sugars, and plant fibers (e.g., without limitation, locust bean and xanthan gums, gum acacia, oat bran, citrus and bean/pea fiber), to optimally control water movement; 4) addition of emulsifiers, stabilizers, divalent cation chelators, and buffers; and 5) addition of oils and fats, either animal or plant sourced, and either singularly or in combination for desired taste, texture and related considerations. Degrees of heating, shear mixing or both may be employed as needed to optimize the resulting composition and shelf stability. It will be understood in the art that, as relates to one or more of the present methods, the scope of this invention comprises variation of any recited order or sequence of steps.

The flavor components of a dairy starting material suitable for use with this invention comprise distinct compounds which originate from major milk constituents or the degradation (e.g., fermentation) thereof: lactose, lipids and proteins (e.g., caseins). More specifically, in the context of a cheese starting material, there is extensive knowledge in the art regarding glycolysis (lactose), lipolysis (lipids) and proteolysis (proteins) of milk constituents, as can be embodied in a cheese curd. Primary degradation of milk constituents leads to the formation of a wide range of precursors of or flavor compounds, some of which directly contribute to cheese flavor; for example, short-chain fatty acids, acetaldehyde diacetyl, peptides, amino acid residues and derivatives thereof. Subsequent catabolic and metabolic pathways further contribute to a complex compound mixture and the unique aroma and flavor profile of a particular variety or type of cheese.

For instance and without limitation, flavor components of gouda cheese attributed to proteolysis include 3-methylbutanal, 3-methylbutanol and methanethiol; flavor components attributed to glycolysis include diacetyl; flavor components attributed to lipolysis include hexanal and pentanal; and flavor components attributed to secondary catabolic pathways include ethyl butyrate and limonene. For cheddar cheese, flavor components attributed to proteolysis include isovaleric acid, methional and methanethiol; flavor components attributed to glycolysis include propanoic acid and diacetyl; flavor components attributed to lipolysis include acetic acid, 1-octen-3-one and butanone; and flavor components attributed to subsequent catabolic pathways include ethyl butyrate and ethyl hexanoate. Flavor components of swiss cheese attributed to proteolysis include methional and 3-methybutanal; flavor components attributed to glycolysis include propanoic acid and diacetyl; and flavor components attributed to subsequent catabolic pathways include ethyl hexanoate, ethyl-3-methylbutanoate and phenylethyl acetate. The flavor components of various other cheeses will be known and understood by those skilled in the art and made aware of this invention and are readily available in the literature.

As mentioned above and discussed elsewhere herein, natural cheeses (e.g., without limitation, mozzarella, cheddar and swiss, etc.) and combinations of natural cheese can be used in conjunction with this invention. In certain embodiments, however, process cheese and enzyme-modified cheese can be used effectively. Process cheese includes pasteurized process cheeses, pasteurized process cheese foods and pasteurized process cheese spreads prepared with an appropriate emulsifying salt (e.g., without limitation, trisodium citrate, disodium phosphate and sodium aluminum phosphate). Enzyme-modified cheese (EMC) is typically prepared by blending cheese curd, optional extraneous ingredients such as fat and protein, with water and emulsifying salts to form a paste which is then pasteurized (to inactivate microorganisms and enzymes) and, optionally, homogenized. A blend of enzymes (e.g., proteinases, peptidases and lipases) is introduced. Microorganisms are, optionally, added to the paste, then deactivated for stabilization. The resulting EMC product is available as a paste or can be dried to powder form, each with a desired moisture content, and incorporated into formulated compositions and food products to provide enhanced cheese flavor. In the context of the present invention, EMC moisture content can be about 2-about 8 wt. %, of which about 3 wt. %-about 4 wt. % can be incorporated into a final snack food flavor/seasoning composition upon lipid/oil extraction and formulation.

The proceeding discussion can be considered in the context of several factors relating to inhibition of microbial growth and shelf stability: water activity, salt-to-moisture (or salt-in-moisture) ratio, hydrogen ion concentration (pH) and titratable acidity.

Water Activity.

Water activity is defined as the ratio of the partial vapor pressure found above the sample of interest to the partial vapor pressure of pure water. The vapor pressure measurements are conducted upon the same sample size at the same temperature, atmospheric pressure, and geometry. For example,

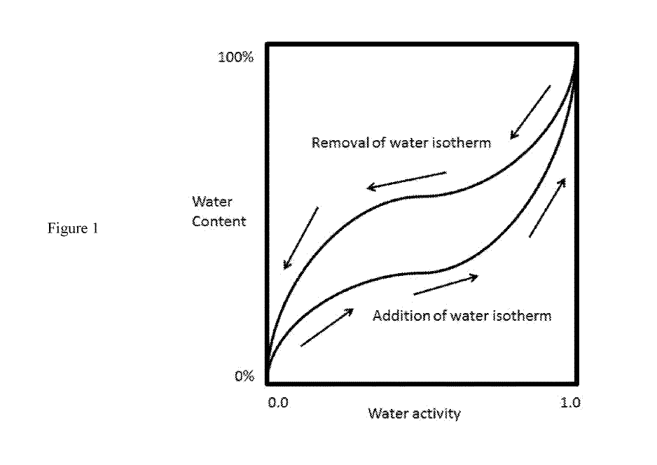

a_{w}=ρ/ρ₀ Equation 1:

Whereas a_{w} is the water activity, expressed as a decimal fraction from 0 to 1. The p is the partial pressure of the water above the sample of interest. The ρ₀ is the partial pressure of water above pure water. It is important to note that water activity is not water (moisture) content. The relationship between water activity and water content, in most cases, is not linearly related. The variable relationship is termed the moisture sorption isotherm. Additionally, depending on whether water is added to the sample or removed from the sample; there may be a different moisture sorption isotherm. FIG. 1 graphically illustrates how moisture sorption isotherms may differ depending if the water is being removed (upper curve) or if the water is being added (lower curve). Analysis of the curve illustrates how it is possible to have the same water content, but vastly different water activity values between two food samples with the same composition. The converse could also be true; it is possible to have the same water activity, but vastly different water content between two food samples with only a difference in water composition.

Salt-to-Moisture Ratio.

The preservation of foods with salt, specifically sodium chloride, has been recognized since almost prehistoric times. In modern times, the use of salt to control microorganisms while still maintaining a degree of edibility requires an understanding of how the salt can be consistently applied with a predictable outcome. A very useful parameter to use is not just the content of the salt added to the food, but rather the content of the salt relative to the water content as well. Those persons skill in the art of salt-induced food preservation would know that lower moisture foods would require less salt for the same degree of preservation than those foods of higher moisture content food and thus requiring more salt. Depending on a selected quality indicator of food preservation, for example microbial inhibition or water-mediated chemical degradation, there can be at many times a predicable outcome based on the ratio of salt percentage relative the water percentage.

Salt-to-moisture=% Salt/% Moisture Equation 2:

An example would be a shelf stable partially dried Parmesan cheese with a moisture content of 18% and a salt content of 4.4%, resulting in a salt-to-moisture ratio of 0.24. This cheese is perfectly suited for shelf stable distribution. Conversely, a Cheddar cheese with a moisture content of 37% and a salt concentration of 1.7% would have a salt-to moisture ratio of 0.046. The Cheddar cheese would require refrigeration for distribution in order to prevent unwanted fermentation and development of off-flavors. Unsurprisingly, many foods may have similar predictions for microbial growth control, relative to each microorganism of interest, based on the salt-to-moisture ratio. It should be noted here that the salt-to-moisture ratio is not the same as another calculated salt and moisture ratio, as noted in the literature; termed salt-in-moisture, herein defined as the ratio of percent salt to both the percent moisture plus the percent salt.

Salt-in-moisture=% Salt/(% Moisture+% Salt) Equation 3:

It is also of interest that other edible salts, which are ionized in water, may also have antimicrobial activities and may have varying levels of effectiveness based on their percentage ratio in water. These edible salts, along with the archetypical sodium chloride, may be used in combination to moderate the degree of perceived saltiness of the food or perhaps exploit the synergy of their combination for microbial inhibition.

The Role of the Hydrogen Ion in Microbial Control.

Since ancient times, the food preservative quality of acids, for example vinegar, had been recognized even though the chemical structure was then unknown. In modern times, the carboxyl group of organic acids will disassociate its hydrogen atom to form the hydroxyl ion, and more specifically a cation. The hydrogen ion will easily take the form of a positively charge cation due to a low electronegativity. The hydrogen cation will rarely exist in water based solutions alone, thus it is well known that is associates with a molecule of water and is call the hydronium ion with a chemical formula of H₃O⁺. A shorthand notation that is use widely is H⁺. The use of the hydronium ion in food preservation is so important that it necessitated methods of measurement; the concept of pH and titratable acidity are some common methods.

The concept of pH is best described through an equation relating to the exponential concentration of the hydronium ion.

pH=−log [H⁺] Equation 4:

Whereas [H⁺] is the concentration of hydronium ion in moles per liter. Note that exponential function is negative, therefore, with increasing concentration of hydronium ion, the pH value is smaller. For example, a very high concentration of acid in solution will have a low pH value than the converse, that is, a dilute acid solution will have a high pH value. The relationship between an ion-selective glass and the resultant electrochemical potential change then forms the basis of the well-know and widely used pH probe and meter, respectfully. Additionally, with foods having either high solids or high ionic load or both, the measurement of pH is less than ideal using the probe and meter method. In those situations, there may be an error in the relationship found in equation 4, so the [H⁺] is best described as hydronium ion activity. With the ease and effectiveness of pH measurement using the probe and meter method, it has become one of the core monitoring methods of food microbial preservation.

Titratable Acidity.

The use of titratable acidity as a method for determining the degree of acidification, as well as the associated microbial preservation, began in the early 1800's as the determination chemical formulas started being known. The use of a titrant, that is a solution containing a reactant at a known concentration, is then added to an unknown solution thought to contain a component of interest that will react with the titrant. As the titrant is added to the unknown, there reaches a point where the reaction is completed. Since the titrant amount was recorded, the determination of the unknown component of interest can be deduced through the reconciliation of the volumes and concentrations. Additionally, there may be used a specialized chemical indicators, typically added at small amounts, to provide indication of a physical change when the reaction between the titrant and component of interest is completed. Typically, known concentrations of basic solutions are used to react with the acids in the sample, for example, a 0.1 N (0.4%) sodium hydroxide, a basic solution, is used to react with vinegar which typically contains about 5% acetic acid. Titratable acidity may have limitations, as the titrant may also react with other materials in the sample. These other materials may have acid chemical properties, but by themselves may not be good at food preservation. An example would be the titration of cheese. The acidification of cheese, which affords a degree of microbial preservation, is predominantly influence by lactic acid. However, associated proteins and minerals react with the titrant and thus contribute the titratable acidity.

The present invention represents a significant departure in the art, with consideration of the inter-relationship of such factors and resulting antimicrobial effect, as demonstrated by the present methods and resulting snack food seasoning and related compositions.

### EXAMPLES OF THE INVENTION

The following non-limiting examples and data illustrate various aspects and features relating to the methods and/or compositions of the present invention, including the preparation of various snack food seasoning compositions, as are available through the methodologies described herein. In comparison with the prior art, the present methods and compositions provide results and data which are surprising, unexpected and contrary thereto. While the utility of this invention is illustrated through the preparation and use of several seasoning compositions and various starting materials/components/agents which can be used therewith, it will be understood by those skilled in the art that comparable results are obtainable with various other preparatory methods and resulting seasoning compositions and corresponding starting materials/components/agents, as are commensurate with the scope of this invention.

### Example 1

In accordance with various non-limiting embodiments of this invention, starting material and components of a white cheese ball seasoning composition are provided below.

| INGREDIENTS | TOTAL % |
|---|---|
| Enzyme-modified cheese* | ~35.0-50.0% |
| Salt, fine flake | ~2.0-6.0% |
| Citric Acid | ~0.1-1.0% |
| Lactic Acid Powder | ~0.1-1.0% |
| DSP anhydrous | ~0.1-1.0% |
| Cottonseed Oil | ~55.0-60.0% |
| Sweet Whey Powder | ~10.0-15.0% |
| Lactose Powder | ~2.0-6.0% |
| Maltodextrin 100 K | ~2.0-6.0% |
| Buttermilk Powder | ~0.5-2.5% |

Such a composition can be prepared by blending salt component(s) (e.g., without limitation, sodium chloride) into a ground, particulate enzyme-modified cheese starting material (* beginning percentage, prior to flavor extraction). In sequence, citric acid and lactic acid components are introduced into the salt/cheese blend. Thereafter, disodium phosphate (DSP) is blended with the acid/salt/cheese. The oil component is added to the resulting blend, then stirred over heat (e.g., about 50° C.-about 60° C.) before cooling and packaging. Of the EMC starting material, about 0.1 to about 10.0 wt. % is extracted from oil, preferably about 3.0 to about 5.0 wt. %.

### Example 1a

In accordance with a formulation of Example 1, after extraction, a flavor-infused seasoning composition is about 3% moisture, about 55% oil and about 3% salt.

### Example 1b

In accordance with another formulation of Example 1, after extraction, a flavor-infused seasoning composition is about 4% moisture, about 57% oil and about 5% salt.

### Example 1c

In accordance with another formulation of Example 1, after extraction, a flavor-infused seasoning composition is about 4% moisture, about 60% oil and about 6% salt.

### Example 1d

In accordance with other formulations of the sort described in Examples 1 and 1a-c, various snack food products (e.g., yellow cheese balls or curls) can be prepared by incorporation of cheddar flavor and colorant (e.g., beta-carotene) ingredients into such seasoning compositions. (These and other EMCs and flavor ingredients are available from Jeneil Biotech, Inc. of Saukville, Wis., USA).

### Example 2

In accordance with various non-limiting embodiments of this invention, starting material and components of another white cheese ball seasoning composition are provided below.

| INGREDIENTS | TOTAL % |
|---|---|
| Enzyme-Modified Cheese | ~35.0-50.0 wt % |
| Salt, fine flake | ~2.0-6.0 wt % |
| Citric Acid | ~0.1-1.0 wt % |
| Lactic Acid Powder | ~0.1-1.0 wt % |
| DSP anhydrous | ~0.1-1.0 wt % |
| Cottonseed Oil | ~45.0-50.0 wt % |
| Sweet Whey Powder | ~10.0-15.0 wt % |
| Lactose Powder | ~2.0-6.0 wt % |
| Maltodextrin 100 K | ~2.0-6.0 wt % |
| Buttermilk Powder | ~0.5-2.5 wt % |

Such a composition can be prepared by blending salt component(s) into an enzyme-modified cheese as described in Example 1 to provide a seasoning composition with about one-third less oil. This more viscose product can afford handling, shipping and storage options. Additional oil can be introduced prior to collet application.

### Example 2a

In accordance with a formulation of Example 1, after extraction, a flavor-infused seasoning composition is about 3% moisture, about 45% oil and about 3% salt.

### Example 2b

In accordance with another formulation of Example 1, after extraction, a flavor-infused seasoning composition is about 4% moisture, about 47% oil and about 5% salt.

### Example 2c

In accordance with another formulation of Example 1, after extraction, a flavor-infused seasoning composition is about 4% moisture, about 50% oil and about 7% salt.

### Example 2d

In accordance with other formulations of the sort described in Examples 2 and 2a-c, various snack food products (e.g., yellow cheese balls or curls) can be prepared by incorporation of cheddar flavor and colorant (e.g., beta-carotene) ingredients into such seasoning compositions. (These and other EMCs and flavor ingredients are available from Jeneil Biotech, Inc. of Saukville, Wis., USA).

### Example 3a

With reference to examples 1 and 2, together with various other compositions and preparatory methods of this invention, a natural cheese starting material can be used alone or in combination with an enzyme-modified cheese to provide a corresponding seasoning composition.

### Example 3b

Various other proteinaceous dairy products/starting materials can be used in conjunction with the methods and compositions of this invention. Such materials include but are not limited to yogurt and cottage cheese. Such dairy starting materials are limited only by water content and formulation sufficient to bind water and afford desired shelf stability, as discussed above and illustrated elsewhere herein.

### Example 3c

With reference to examples 1 and 2, together with various other compositions of this invention, an enzyme-modified cheese without an emulsifier can be utilized to provide, as it would be understood in the art, a clean label product.

### Example 3d

Regardless of identity of dairy product or cheese, such a starting material can be provided as a ground particulate, the size of which can be varied to meet various formulation and processing concerns.

### Example 4a

With reference to examples 1 and 2, temperature can be varied as needed to provide desired extraction of flavor from a dairy/cheese starting material into an oil component. Such heating can also provide an antimicrobial effect.

### Example 4b

With reference to the preceding example, depending on temperature, such an oil component blend can be stirred for a time extending from minutes to hours to days; that is, for a time sufficient for desired flavor extraction.

### Example 5

Various compositions of the present invention can also comprise one or more calcium salts (e.g., carbonate or sulfate) in an amount as can range from about 2 wt. % to about 3 wt. % of the seasoning composition.

### Example 6a

Various compositions of this invention can also include a wide range of additional ingredient components, such as but not limited to flavors, spices, additional fats or oils, nutritive and non-nutritive sweeteners, colorants (natural and non-natural, the latter which include e.g., beta-carotene, turmeric, annato, etc.), vitamins and minerals and combinations thereof, as may be needed to meet desired aroma, flavor, mouthfeel, appearance and nutritive objectives.

### Example 6b

For instance, with reference to Examples 1, 2 and 6A, appropriate flavors, oils and colorants, together with a suitable cheese starting material, can be used to provide garlic, jalapeno, ranch and pizza-flavored seasoning compositions.

### Example 7

Without limitation, various compositions of this invention can also include live cultures (e.g., yogurt cultures, etc.), probiotics, neutraceuticals, bacteriocins and deactivated cultured ingredient additions (e.g., heat deactivated cultured skim milk).

### Example 8

Various compositions of this invention can also include, without limitation, antioxidants and other commercially-available preservatives to extend shelf life of such a seasoning composition, a final food product or both.

### Example 9

Various compositions of this invention can also be designed to incorporate flavors or flavor combinations based on ethnic tradition or common folk recipes. Likewise, such flavors or combinations can be designed as may be suitable for pet or animal palatability.

### Example 10a

With respect to a snack food composition of this invention, a collet can be derived from corn, wheat, rice, potato, peanut, soy, milk proteins, grains, legumes, fruits, vegetables, tree nuts, starches, gums, hydrocolloids and the like or combinations thereof.

### Example 10b

Regardless of composition, the size of a collet can include but is not limited to the following: (1) a large single piece, suitable for division into single servings; (2) an extruded bar-like single serving; (3) single bit-sized servings; (4) kibbles and flakes; and (5) small “crackles” suitable for texturants or otherwise useful in other food applications.

### Example 10c

Regardless of collet composition or size, a seasoning composition in this invention can be incorporated therein by any process or method known to those skilled in the art. Without limitation, a seasoning composition of this invention can be sprayed onto a collet, using any suitable equipment or technique. Alternatively, utilizing appropriate equipment or techniques, a collet can be tumbled through or immersed in such a seasoning composition. Regardless, such a lipid/oil-based seasoning composition can be adsorbed on, absorbed into the collet or incorporated by both adsorption and absorption. With reference to Example 4B and the preceding discussion, with optimal extraction, the oil component of such a seasoning can transfer full flavor to the collet for an enhanced taste sensation.

We claim:

1. A method of preparing a snack food flavor and seasoning composition, said method comprising:
providing a proteinaceous dairy starting material comprising an aqueous phase and flavor components;
blending a salt component with said dairy starting material, said salt component in an amount for incorporation into said aqueous phase; and
contacting said dairy starting material and said salt component with an oil component, with mixing said components and starting material for at least one of a time and at a temperature sufficient for extraction of said flavor components into said oil, to provide a snack food flavor/seasoning composition.

2. The method of claim 1 wherein said dairy starting material is selected from natural cheeses, enzyme-modified cheeses and combinations thereof.

3. The method of claim 2 wherein said dairy starting material aqueous phase is the sole source of water in said preparation.

4. The method of claim 1 wherein said salt component is selected from alkaline and alkaline earth chlorides and phosphates and combinations thereof.

5. The method of claim 4 wherein said dairy starting material aqueous phase is saturated with said salt component.

6. The method of claim 1 at a temperature to provide a fluidity sufficient for mixing without agglomeration.

7. The method of claim 6 wherein said dairy starting material and said components are mixed at a temperature of about 5° C. to about 99° C.

8. The method of claim 7 wherein said temperature is about 50° C. to about 60° C.

9. The method of claim 1 wherein said oil component is selected from vegetable, cottonseed, canola and olive oils and combinations thereof.

10. The method of claim 1 incorporating an acid component to at least one of said dairy starting material, salt component and said blended components, said acid component selected from organic acids, salts of said organic acids and combinations thereof, said acid component in an amount sufficient to provide said composition a pH of less than about 6.0.

11. The method of claim 1 incorporating a water binding agent selected from calcium carbonate, calcium phosphate, calcium sulfate, dry plant and animal proteins and protein fractions, carbohydrates and cellulosic components and combinations thereof, said binding agent in an amount sufficient to bind with said aqueous phase.

12. The method of claim 11 wherein said binding agent is in an amount to provide said composition without free water and inhibit water separation therefrom.

13. The method of claim 1 wherein said composition is incorporated with a snack collet.

14. The method of claim 13 wherein said incorporation is selected from surface application to and co-extrusion with said snack collet.

15. A method of preparing a snack food flavor and seasoning composition, said method comprising:
providing an enzyme-modified cheese starting material comprising an aqueous phase and flavor components;
blending a salt component with said cheese starting material, said salt component in an amount sufficient to provide a salt-in-moisture ratio of about 0.15 to about 0.75;
blending an acid component with at least one of said cheese starting material, salt component and said blended cheese material and said salt component, said acid component selected from organic acids, salts of said organic acids and combinations thereof, said acid component in an amount sufficient to provide said composition a pH of less than about 6.0; and
contacting said blended cheese starting material and said salt and acid components with an oil component, with mixing said components and starting material for at least one of a time and at a temperature sufficient for extraction of said flavor components into said oil, to provide a snack food flavor/seasoning composition with at least one of a pH, water activity and salt-in-moisture ratio sufficient to inhibit microbial growth.

16. The method of claim 15 wherein said salt-in-moisture ratio is about 0.20 to about 0.60.

17. The method of claim 15 wherein said cheese starting material aqueous phase is the sole source of water in said preparation.

18. The method of claim 15 wherein said salt component is selected from alkaline and alkaline earth chlorides and phosphates and combinations thereof.

19. The method of claim 15 wherein said cheese starting material and said components are mixed at a temperature of about 5° C. to about 99° C.

20. The method of claim 19 wherein said temperature is about 50° C. to about 60° C.

21. The method of claim 15 wherein said oil component is selected from vegetable, cottonseed, canola and olive oils and combinations thereof.

22. The method of claim 15 incorporating a water binding agent selected from calcium carbonate, calcium phosphate, calcium sulfate, dry plant and animal proteins and protein fractions, carbohydrates and cellulosic components and combinations thereof, said binding agent in an amount sufficient to bind with said aqueous phase and inhibit separation of water therefrom.

23. The method of claim 15 wherein said composition is incorporated with a snack collet.

24. The method of claim 23 wherein said incorporation is selected from surface application to and co-extrusion with said snack collet.

25. A snack seasoning composition comprising: a lipid component selected from oils, fats and combinations thereof; a seasoning component comprising a cheese flavor component and water component; a salt component in an amount sufficient to provide said composition a salt-in-moisture ratio of about 0.15 to about 0.75; an acid component selected from organic acids, salts of said organic acids and combinations thereof, said acid component providing said composition of a pH of about 4.0 to about 5.0, said composition with at least one of a pH, water activity and salt-in-moisture ratio sufficient to inhibit microbial growth.

26. The composition of claim 25 wherein said cheese flavor component is selected from natural cheese flavors, enzyme-modified cheese flavors and combinations thereof.

27. The composition of claim 26 wherein said seasoning water component is the sole source of water in said composition.

28. The composition of claim 25 wherein said salt component is selected from alkaline and alkaline earth chlorides and phosphates and combinations thereof.

29. The composition of claim 28 wherein said seasoning water component is saturated with said salt component.

30. The composition of claim 25 wherein said lipid component comprises an oil selected from cottonseed, vegetable, canola and olive oils and combinations thereof.

31. The composition of claim 30 wherein said oil component is about 45 wt. % to about 70 wt. % of said composition.

32. The composition of claim 25 comprising a water binding agent selected from calcium carbonate, calcium phosphate, calcium sulfate, dry plant and animal proteins and protein fractions, carbohydrates and cellulosic components and combinations thereof, said binding agent in an amount sufficient to bind with said seasoning water component.

33. The composition of claim 32 wherein said binding agent is in an amount to provide said composition without free water and inhibit water separation therefrom.

34. A snack seasoning composition comprising: a lipid component selected from oils, fats and combinations thereof; a seasoning component comprising a cheese flavor component and water component, said water component the sole source of water in said composition; a salt component in an amount sufficient to provide said composition a salt-in-moisture ratio of about 0.15 to about 0.75; an acid component selected from organic acids, salts of said organic acids and combinations thereof, said acid component providing said composition of a pH of about 4.0 to about 5.0, said composition with at least one of a pH, water activity and salt-in-moisture ratio sufficient to inhibit microbial growth.

35. The composition of claim 34 wherein said cheese flavor component is selected from natural cheese flavors, enzyme-modified cheese flavors and combinations thereof.

36. The composition of claim 35 wherein said cheese flavor component comprises an enzyme-modified cheese flavor extract.

37. The composition of claim 34 wherein said salt component is selected from alkaline and alkaline earth chlorides and phosphates and combinations thereof.

38. The composition of claim 34 wherein said lipid component comprises an oil selected from cottonseed, vegetable, canola and olive oils and combinations thereof.

39. The composition of claim 38 wherein said oil is about 45 wt. % to about 70 wt. % of said composition.

40. The composition of claim 34 comprising a water binding agent selected from calcium carbonate, calcium phosphate, calcium sulfate, dry plant and animal proteins and protein fractions, carbohydrates and cellulosic components and combinations thereof, said binding agent in an amount sufficient to bind with said seasoning water component.

41. A snack food composition comprising a snack food collet and a composition selected from compositions of claim 25 and claim 34.

42. The composition of claim 40 wherein said collet comprises a material comprising a component selected from wheat, rice, potato, peanut, soybean and corn meal.

43. The composition of claim 40 wherein said flavor composition is applied to the surface of said collet.

44. The composition of claim 43 wherein said flavor composition is incorporated within said collet.
